(19) United States
(12) Patent Application Publication
(10) Pub. No.: US 2010/0096574 A1
(43) Pub. Date: Apr. 22, 2010

(54) THROTTLE VALVE HAVING MAGNETIC FLUID SEAL STRUCTURE

(76) Inventor: Gyu-Tae Son, Gyeonggi-do (KR)

Correspondence Address: CHRISTOPHER PAUL MITCHELL, 888 16TH ST., NW, SUITE 800, WASHINGTON, DC, 20006, US

(21) Appl. No.: 12/447,902

(22) PCT Filed: Oct. 4, 2007
(86) PCT No.: PCT/KR07/04835

§ 371 Date: Apr. 29, 2009

(30) Foreign Application Priority Data
Nov. 9, 2006 (KR) 10-2006-0110242

(51) Int. Cl. F16K 41/00; F16K 31/04

(52) U.S. Cl. 251/129.11

(57) ABSTRACT

A throttle valve having a magnetic fluid seal structure, which includes a main plate installed at an end of an outlet of a chamber, an opening/closing plate installed at an inside of the main plate, an electric motor coupled to a rotation shaft of the opening/closing plate and a driving unit disposed between the opening/closing plate and the electric motor, wherein the driving unit includes a housing for covering a portion between the main plate and the electric motor and bearings which are coupled to inner opposite sides of the housing to support the rotation shaft, the throttle valve including magnetic members which are coupled to inner sides of the bearings disposed at opposite sides of the driving unit and have annular seal grooves formed on outer surfaces in close contact with an inner surface of the housing, and magnetic fluids filled in the seal grooves in a colloidal state in which magnetic fine particles are mixed with liquid.

### BACKGROUND OF THE INVENTION

1. Field of the Invention

The present invention relates to a throttle valve for regulating a pressure, and more particularly to a throttle valve having a magnetic fluid seal structure capable of preventing loss through the throttle valve and improving the reliability of a product.

2. Description of the Related Art

Generally, a throttle valve is installed in a line to control the effective cross-sectional area, thereby regulating the amount of a fluid or gas passing therethrough.

Specifically, as shown in FIGS. 1 and 2, the throttle valve includes a main plate 10 installed at the end of an outlet of a chamber, an opening/closing plate 20 installed at the inside of the main plate 10, an electric motor 30 coupled to a rotation shaft 22 of the opening/closing plate 20, and a driving unit 40 disposed between the opening/closing plate 20 and the electric motor 30.

The driving unit 40 supports the rotation shaft 22 which connects the opening/closing plate 20 to the electric motor 30 to perform a smooth operation, and also prevents loss generated through the rotation shaft 22.

That is, the driving unit 40 includes a housing 42 which is formed at one side of the main plate 10 as a single body to cover the rotation shaft 22, bearings 44 which are coupled to the inner opposite sides of the housing 42 to support the rotation shaft 22, and O-rings 46 which are coupled to the outer side or inner side of the bearings 44 to prevent leakage between the rotation shaft 22 and the cover. However, according to the above-mentioned configuration, there is a problem such that a sealing structure or reliability of the O-rings deteriorates after a certain period of time. That is, since the O-rings wear down after the throttle valve is used for a specified period of time, a pressure or gas loss may occur through a gap. Also, since the vibration occurs during the operation due to fine particles generated due to the abrasion, a smooth rotation cannot be achieved and the reliability of the operation is reduced.

Moreover, when the throttle valve is used to regulate a pressure in a chamber in the high-integration semiconductor field, although the problem is not severe, it causes a large problem in providing high-quality products.

Thus, although the problem is small, it is required to radically solve the problem and an improvement is urgent.

Further, according to the above-mentioned conventional driving unit 40, since the housing 42 for covering the rotation shaft 22, the bearings 44 and the O-rings 46 is formed at one side of the main plate 10 as a single body, there is a problem such that replacement and management are inconvenient when the abrasion of the O-rings 46 or the housing 42 is generated.

### SUMMARY OF THE INVENTION

Therefore, the present invention has been made in view of the above problems, and it is an object of the present invention to provide a throttle valve having a magnetic fluid seal structure capable of preventing loss through the throttle valve and improving the reliability of a product.

It is another object of the present invention to provide a throttle valve having a magnetic fluid seal structure capable of continuously inspecting and conveniently monitoring the magnetic fluid seal structure and easily replacing and repairing a portion with a reduced function.

In accordance with an aspect of the present invention, there is provided a throttle valve having a magnetic fluid seal structure, which includes a main plate installed at an end of an outlet of a chamber, an opening/closing plate installed at an inside of the main plate, an electric motor coupled to a rotation shaft of the opening/closing plate and a driving unit disposed between the opening/closing plate and the electric motor, wherein the driving unit includes a housing for covering a portion between the main plate and the electric motor and bearings which are coupled to inner opposite sides of the housing to support the rotation shaft, the throttle valve comprising: magnetic members which are coupled to inner sides of the bearings disposed at opposite sides of the driving unit and have annular seal grooves formed on outer surfaces in close contact with an inner surface of the housing; and magnetic fluids filled in the seal grooves in a colloidal state in which magnetic fine particles are mixed with liquid.

Preferably, the housing is formed to be fastened between the main plate and the electric motor.

Preferably, a transparent window is formed on an outer surface of the housing such that a state of the magnetic fluids of the magnetic fluid seals is checked.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an application state diagram showing a conventional throttle valve having an O-ring structure;

FIG. 2 shows a partially cutaway perspective view of the conventional throttle valve having an O-ring structure;

FIG. 3 illustrates an application state diagram showing a throttle valve having a magnetic fluid seal structure according to one embodiment of the present invention;

FIG. 4 illustrates a partially cutaway perspective view of the throttle valve having a magnetic fluid seal structure according to the embodiment of the present invention;

FIG. 5 illustrates a cross-sectional view of FIG. 4;

FIG. 6 illustrates a perspective view of a throttle valve having a magnetic fluid seal structure according to another embodiment of the present invention; and

FIG. 7 illustrates a cross-sectional view of FIG. 6.

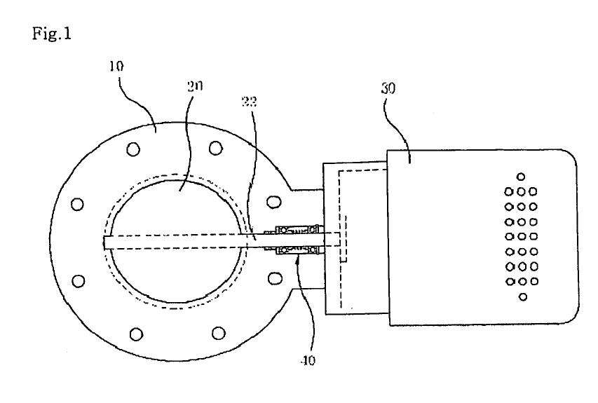

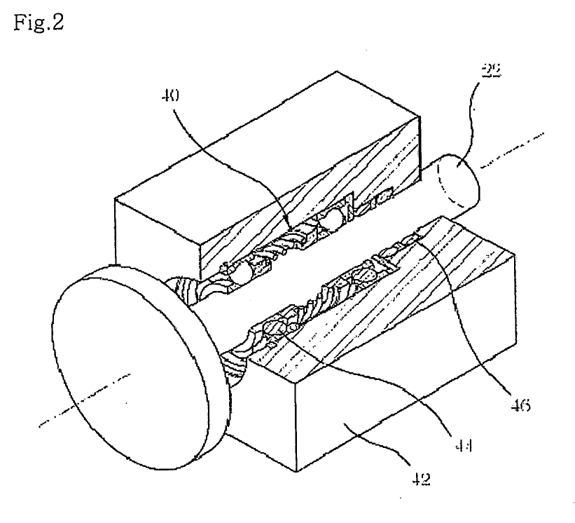

### DETAILED DESCRIPTION OF THE PREFERRED EMBODIMENTS

Hereinafter, embodiments of the present invention will be described in detail with reference to the accompanying drawings.

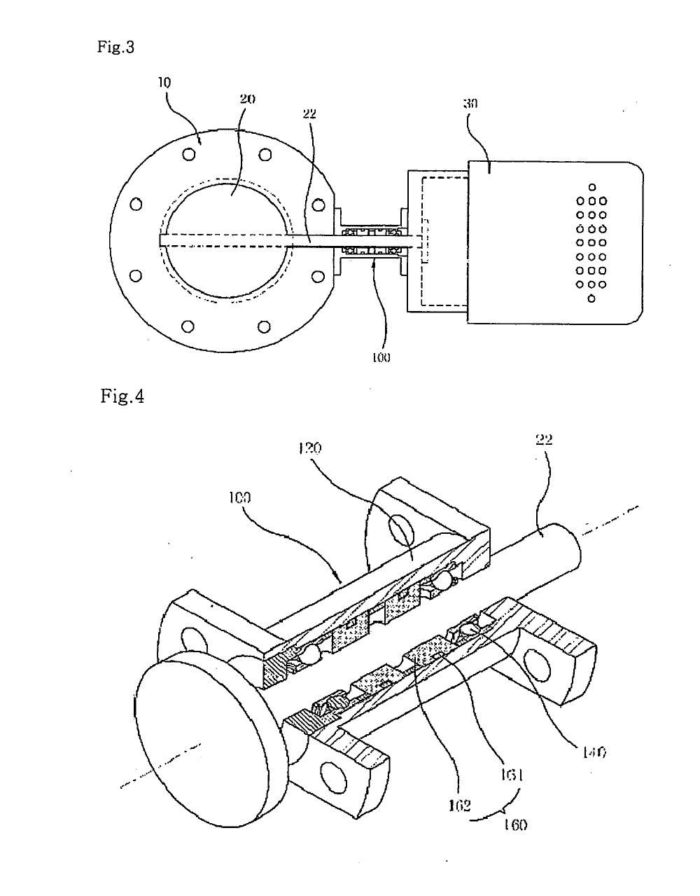

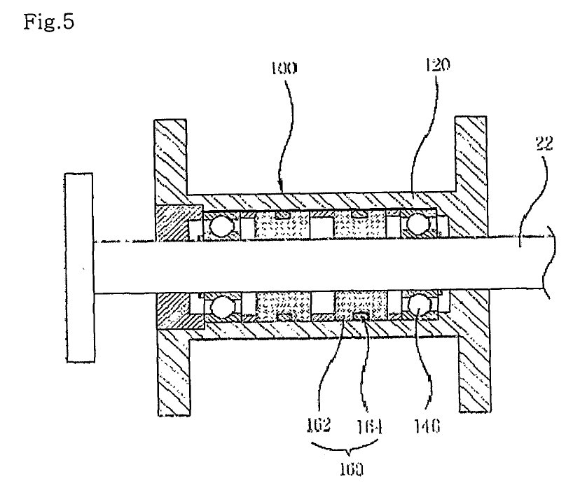

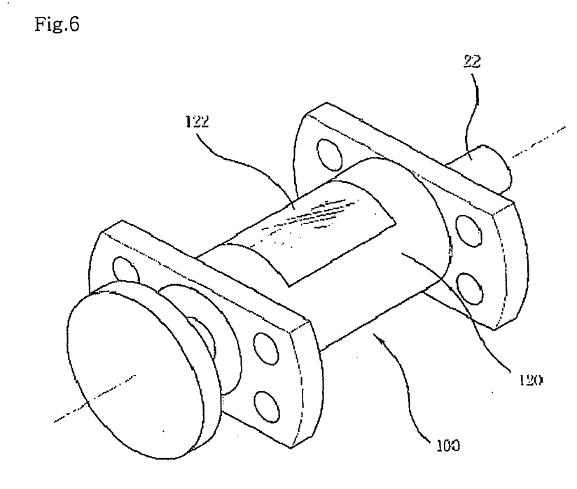

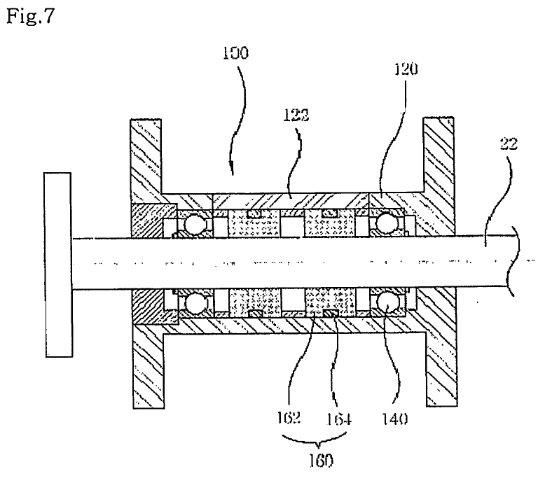

FIG. 3 illustrates an application state diagram showing a throttle valve having a magnetic fluid seal structure according to one embodiment of the present invention. FIG. 4 illustrates a partially cutaway-perspective view of the throttle valve having a magnetic fluid seal structure according to the embodiment of the present invention. FIG. 5 illustrates a cross-sectional view of FIG. 4. FIG. 6 illustrates a perspective view of a throttle valve having a magnetic fluid seal structure according to another embodiment of the present invention. FIG. 7 illustrates a cross-sectional view of FIG. 6.

As shown in FIGS. 3 to 7, the throttle valve having a magnetic fluid seal structure according to the present invention includes a main plate 10 installed at the end of an outlet of a chamber, an opening/closing plate 20 installed at the inside of the main plate 10, an electric motor 30 coupled to a rotation shaft 22 of the opening/closing plate 20, and a driving unit 100 disposed between the opening/closing plate 20 and the electric motor 30. Particularly, the present invention has a feature in the configuration of the driving unit.

The driving unit 100 includes a housing 120 for covering a portion between the main plate 10 and the electric motor 30, bearings 140 which are coupled to the inner opposite sides of the housing 120 to support the rotation shaft 22, and magnetic fluid seals 160 which are coupled and installed between the bearings 44 of the opposite sides.

The housing 120 is formed to be attached and detached between the main plate 10 and the electric motor 30. That is, the housing 120 is formed independently from the main plate 10 and the electric motor 30 to be fastened by bolts such that the housing 120 can be easily and conveniently separated to replace and repair the bearings 140 and the magnetic fluid seals 160.

Meanwhile, preferably, a transparent window 122 is formed on an outer surface of the housing 120 such that a state of magnetic fluids 164 of the magnetic fluid seals 160 can be checked. That is, the transparent window 122 is formed of a glass material having high durability and strength or a synthetic resin material. Accordingly, it is possible to easily check and deal with a dry state or remaining state of the magnetic fluids 164 to be described later.

The bearings 140 are formed of commonly-used ball bearings or roller bearings to support the rotation shaft 22 for a smooth rotation of the opening/closing plate 20. The magnetic fluid seals 160 are coupled to the inner sides of the bearings 140 disposed at the opposite sides of the driving unit 100. The magnetic fluid seals 160 include magnetic members 162 having annular seal grooves formed on their outer surfaces in close contact with an inner surface of the housing 120 and the magnetic fluids 164 filled in the seal grooves in a colloidal state in which magnetic fine particles are mixed with liquid.

That is, the magnetic fluid seals 160 include the magnetic fluids 164 having one polarity in which magnetic fine particles with a size of about 20 nm are especially processed, and the circular magnetic members 162 having the other polarity to maintain a condensed state of the magnetic fluids 164. Since the magnetic fluids 164 are closely contacted with a rotation surface in a condensed state by the magnetic members 162, it is possible to prevent loss of an inner pressure or gas.

In this case, the magnetic fluids 164 can be applied to a sealing technology since the magnetic fine particles are uniformly distributed without being deposited in the liquid and behave similarly to molecules.

Further, when the magnetic fluid seals 160 are used, the abrasion is small even in the state closely contacted with a rotation surface, thereby increasing its life span and improving the stability.

As described above, according to the throttle valve having a magnetic fluid seal structure of the present invention, it is possible to prevent loss through the throttle valve and improve the reliability of a product. Accordingly, the present invention has the effects of improving the productivity and the competitiveness of a product. Further, it is possible to continuously inspect and conveniently monitor the magnetic fluid seal structure and easily replace and repair a portion with a reduced function. Thus, the present invention has an effect of improving the stability of production. Although the preferred embodiment of the present invention has been disclosed for illustrative purposes. those skilled in the art will appreciate that various modifications, additions and substitutions are possible, without departing from the scope and spirit of the invention as disclosed in the accompanying claims.

What is claimed is:

1. A throttle valve having a magnetic fluid seal structure, which includes a main plate installed at an end of an outlet of a chamber, an opening/closing plate installed at an inside of the main plate, an electric motor coupled to a rotation shaft of the opening/closing plate and a driving unit disposed between the opening/closing plate and the electric motor, wherein the driving unit includes a housing for covering a portion between the main plate and the electric motor and bearings which are coupled to inner opposite sides of the housing to support the rotation shaft, the throttle valve comprising:
magnetic members which are coupled to inner sides of the bearings disposed at opposite sides of the driving unit and have annular seal grooves formed on outer surfaces in close contact with an inner surface of the housing; and
magnetic fluids filled in the seal grooves in a colloidal state in which magnetic fine particles are mixed with liquid.

2. The throttle valve according to claim 1, wherein the housing is formed to be fastened between the main plate and the electric motor.

3. The throttle valve according to claim 2, wherein a transparent window is formed on an outer surface of the housing such that a state of the magnetic fluids of the magnetic fluid seals is checked.
